(19) United States
(12) Patent Application Publication
(10) Pub. No.: US 2019/0281195 A1
(43) Pub. Date: Sep. 12, 2019

(54) IMAGE CAPTURING DEVICE

(71) Applicants: LITE-ON ELECTRONICS (GUANGZHOU) LIMITED, GUANGZHOU (CN); Lite-On Technology Corporation, Taipei (TW)

(72) Inventor: Chen-Cheng Weng, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 16/024,926

(22) Filed: Jul. 2, 2018

(30) Foreign Application Priority Data
Mar. 6, 2018 (CN) 201820305745.2

(51) Int. Cl. H04N 5/225; G02B 7/02; G02B 27/09

(52) U.S. Cl. CPC H04N 5/2252; H04N 5/2254; G02B 27/0955; G02B 7/02; H04N 5/2256

(57) ABSTRACT

An image capturing device includes a case, a lens module, at least one illuminant module and at least one light blocking component. The case includes a front cover having a transparent region. The lens module is arranged in the case and oriented toward the transparent region. The illuminant module is arranged in the case and oriented toward the transparent region. The light blocking component is laterally arranged on an inner side of the front cover. The light blocking component separates the lens module from the illuminant module and divides the transparent region into a first portion and at least one second portion. The lens module corresponds to the first portion of the transparent region, and the illuminant module corresponds to the second portion of the transparent region.

### CROSS REFERENCE TO RELATED APPLICATION

This application claims the priority benefit of China application serial no. 201820305745.2, filed on Mar. 6, 2018. The entirety of the above-mentioned patent application is hereby incorporated by reference herein and made a part of specification.

### BACKGROUND

### Field of the Invention

The invention relates to an image capturing device and more particularly, to an image capturing device having preferable image capturing quality.

### Description of Related Art

In recent years, home appliance products with networking capability have been vigorously developed, which contributes to the growth on users' demands for remote monitoring, and as people's safety consciousness for homes or public locations keeps to be increased, the installation of monitors has been increasingly popular. For the demands for the monitors used in ordinary lanes or darker indoor areas, the monitors are usually disposed with additional filling light source to compensate for the light insufficiency of the user environment. However, when a monitor is operated, an image obtained by a lens may be influenced due to a filling light source being reflected or refracted by a transparent front cover of the monitor.

### SUMMARY

The invention provides an image capturing device having preferable image capturing quality.

An image capturing device of the invention includes a case, a lens module, at least one illuminant module and at least one light blocking component. The case includes a front cover having a transparent region. The lens module is arranged in the case and oriented toward the transparent region. The at least one illuminant module is arranged in the case and oriented toward the transparent region. The at least one light blocking component is laterally arranged at the transparent region of the front cover. The at least one light blocking component separates the lens module from the at least one illuminant module and divides the transparent region into a first portion and at least one second portion. The lens module corresponds to the first portion of the transparent region, and the at least one illuminant module corresponds to the at least one second portion of the transparent region.

To sum up, the image capturing device of the embodiments of the invention, with the light blocking component laterally arranged on the front cover of the case, can achieve dividing the transparent region of the front cover into the first portion corresponding to the lens module and the second portion corresponding to the illuminant module. The light blocking component can block the light of the illuminant module from being reflected or refracted by the front cover into the lens module, thereby protecting the image quality captured by the lens module from being influenced.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view showing an image capturing device according to an embodiment of the invention.

FIG. 2 is a schematic exploded view showing the image capturing device of embodiment depicted in FIG. 1.

FIG. 3 is a schematic front view showing the image capturing device of embodiment depicted in FIG. 1.

FIG. 4 is a schematic front view showing the front cover of the image capturing device of embodiment depicted in FIG. 1.

FIG. 5 is a schematic front top view showing the front cover of the image capturing device of embodiment depicted in FIG. 1.

FIG. 6 is a schematic rear top view showing the front cover of the image capturing device of embodiment depicted in FIG. 1.

FIG. 7 is cross-sectional view of FIG. 3 taken through section line A-A′ which is parallel to the Y-Z plane illustrating a region near the front cover.

FIG. 8 is cross-sectional view of FIG. 3 taken through section line A-A′ which is parallel to the Y-Z plane illustrating a region near the front cover according to another embodiment of the invention.

### DESCRIPTION OF EMBODIMENTS

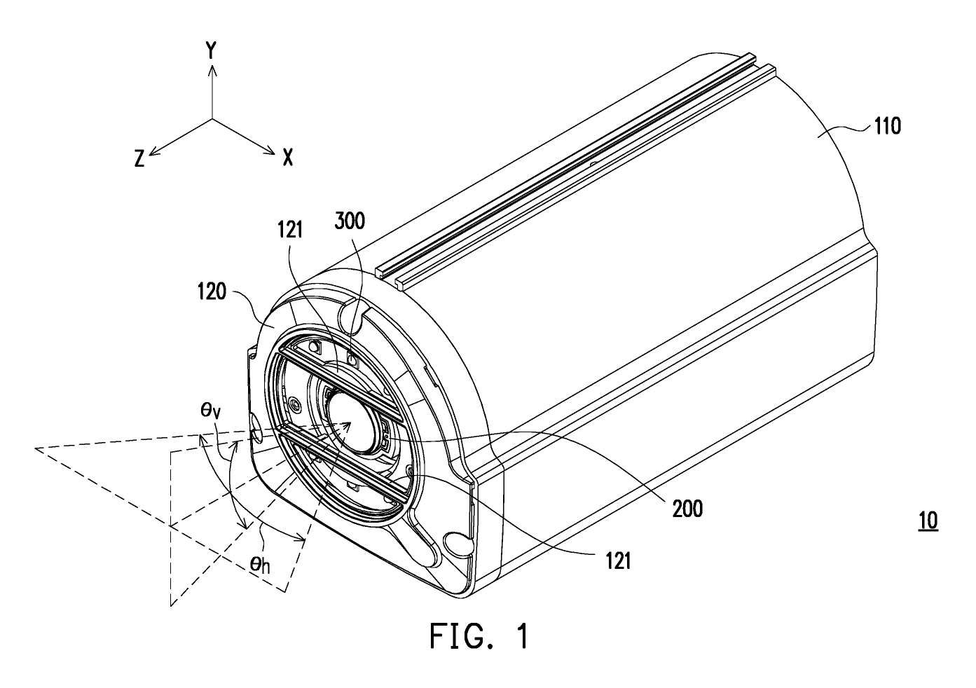

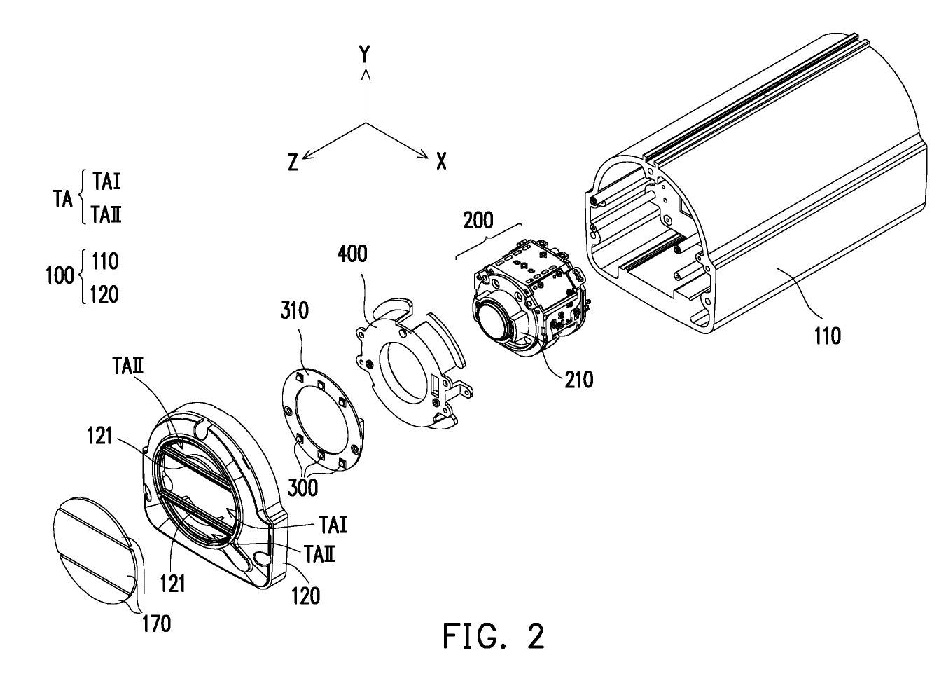

FIG. 1 is a schematic perspective view showing an image capturing device according to an embodiment of the invention. FIG. 2 is a schematic exploded view showing the image capturing device of embodiment depicted in FIG. 1. Referring to FIG. 1 and FIG. 2, an image capturing device 10 of the present embodiment includes a case 100, a lens module 200, a plurality of illuminant modules 300 and at least one light blocking component 121. In the present embodiment, the image capturing device 10 is, for example, a monitor, but may also be a camera or a video camera. The type of the image capturing device 10 is not limited thereto. The lens module 200 is employed to capture images, the illuminant modules 300 are employed to fill light for the environment, and the light blocking component 121 is employed to block light emitted by the illuminant module 300 from irradiating, being reflected or refracted into the lens module 200. Additionally, in the present embodiment, the number of the light blocking components 121 is two, for example, and the two light blocking components are separated from each other, without being directly connected with each other. However, the number and the disposition positions of the light blocking components 121 are not limited thereto.

As illustrated in FIG. 2, in the present embodiment, the case 100 has a front cover 120, the front cover 120 has a transparent region TA. The lens module 200 and the illuminant modules 300 are respectively arranged in the case 100 and oriented toward the transparent region TA. The two light blocking components 121 are laterally arranged in the transparent region TA of the front cover 120, thereby dividing the transparent region TA into a first portion TAI and two second portions TAII. The lens module 200 corresponds to the first portion TAI of the transparent region TA, a part of the illuminant modules 300 correspond to one of the second portions TAII of the transparent region TA, and the other part of the illuminant modules 300 correspond to the other one of the second portions TAII of the transparent region TA, but the invention is not limited thereto. In another embodiment, it may also be only one light blocking component 121 disposed in the transparent region TA of the front cover 120, thereby dividing the transparent region TA into a first portion TAI and a second portion TAII. The lens module 200 corresponds to the first portion TAI of the transparent region TA, and the illuminant modules 300 correspond to the second portion TAII of the transparent region TA.

Referring to FIG. 1 and FIG. 2, in the present embodiment, the case 100 of the image capturing device 10 further includes a main body portion 110 and three transparent cover plates 170. The front cover 120 is detachably assembled to the main body portion 110, and the three transparent cover plates 170 are respectively arranged in the first portion TAI and the two second portions TAII of the transparent region TA of the front cover 120, thereby protecting the lens module 200 and the illuminant modules 300 for dustproof and waterproof to reduce a probability of being hit and damaged by an external object. In the present embodiment, the transparent cover plates 170 are made of a transparent material, for example, plastic, acrylic or glass, and the illuminant modules 300 are infrared illuminant modules and arranged on a carrier 310, but the invention is not limited thereto.

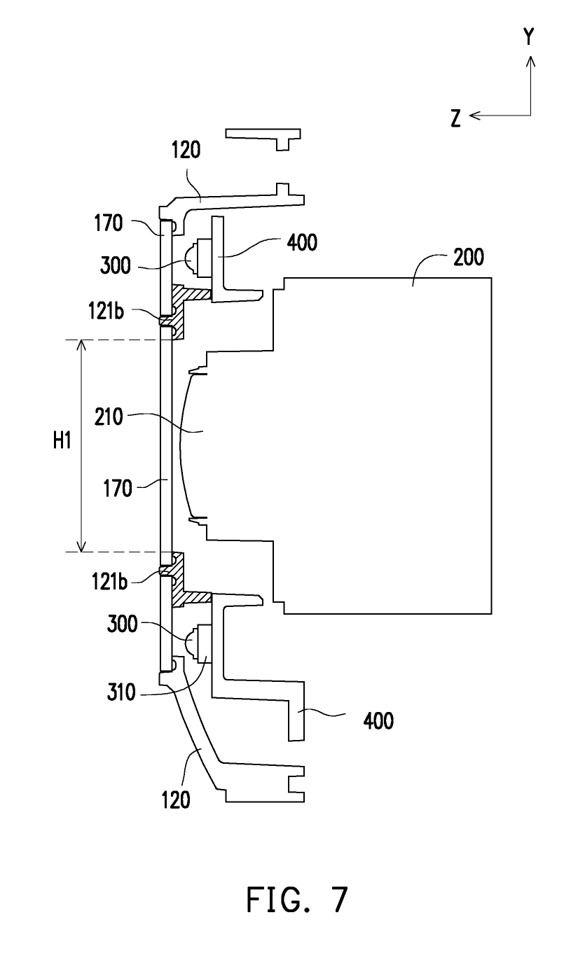

Referring to FIG. 2, in the present embodiment, the image capturing device 10 further includes a support base 400 arranged in the case 100 and surroundingly disposed at a lens 210 of the lens module 200. In the present embodiment, the illuminant modules 300 are arranged on the support base 400, and the light blocking components 121 of the front cover 120 may be supported on the support base 400 (as illustrated in FIG. 7), thereby providing preferable structure strength, but the invention is not limited thereto.

Returning to FIG. 1, the lens module 200 has a vertical field angle θv in a vertical direction (i.e., the Y-axis) and a horizontal field angle θh in a horizontal direction (i.e., the X-axis). If an object in front of the lens module 200 is located outside a range covered by the vertical field angle θv or the horizontal field angle θh, such that the lens module 200 does not capture an image of the object. In other words, the object does not influence the image captured by the lens module 200.

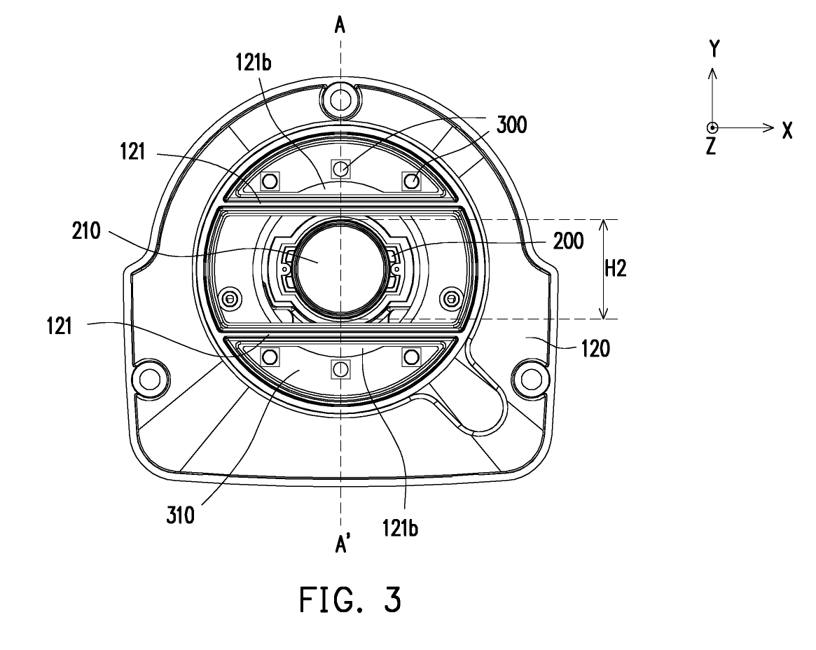

Additionally, the vertical field angle θv of the lens module 200 in the vertical direction (i.e., the Y-axis) is smaller than the horizontal field angle θh in the horizontal direction (i.e., the X-axis). Thus, a scenario where two objects are located in front of the lens module 200 is taken for example, and in order to prevent the two objects located in front of the lens module 200 from influencing the image captured by the lens module 200, a spacing between the two objects when being arranged along the vertical direction may be smaller than a spacing when the two objects are arranged along the horizontal direction. In the present embodiment, for the image capturing device 10, the two light blocking components 121 may be laterally arranged on the front cover 120 (i.e., in the horizontal direction, or in other words, the X-axis direction in the figure) by utilizing this feature, as long as the two light blocking components 121 are located outside the range covered by the vertical field angle θv. Even though the two light blocking components 121 are quite adjacent to a height H2 of the lens 210 of the lens module 200 in the vertical direction (i.e., the Y-axis) (referring to FIG. 3), the two light blocking components 121 still do not influence the image captured by the lens module 200.

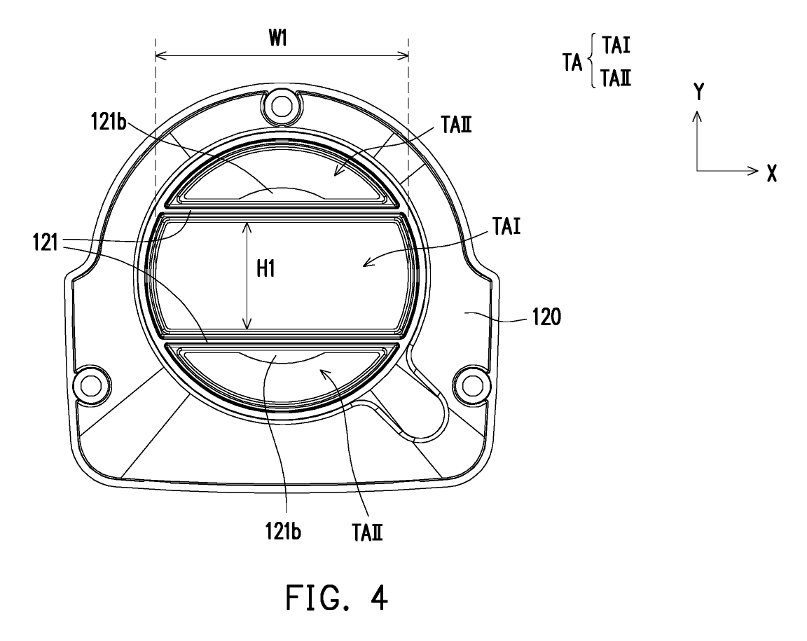

FIG. 3 is a schematic front view showing the image capturing device of embodiment depicted in FIG. 1. FIG. 4 is a schematic front view showing the front cover of the image capturing device of embodiment depicted in FIG. 1. Referring to FIG. 3 and FIG. 4, in the present embodiment, there is a spacing H1 (referring to FIG. 4) between the two light blocking components 121 in the vertical direction (i.e., the Y-axis), while the lens 210 of the lens module 200 has a height H2 in the vertical direction (i.e., the Y-axis) (referring to FIG. 3), and the height H2 of the lens 210 of the lens module 200 is smaller than the spacing H1 between the two light blocking components 121. However, the invention is not limited thereto, and in another embodiment, the height H2 of the lens 210 of the lens module 200 may be equal to the spacing H1 between the two light blocking components 121, as long as the two light blocking components 121 are located outside the range covered by the vertical field angle θv.

In the present embodiment, ranges of the first portion TAI and the second portions TAII of the transparent region TA of the front cover 120 are defined by the two light blocking components 121, the illuminant modules 300 are disposed at positions corresponding to the two second portions TAII of the transparent region TA, and thus, the more adjacency of the two light blocking components 121 represents that the region for the disposition of the illuminant modules 300 is larger. Thus, in the present embodiment, the two light blocking components 121 are specially designed to be laterally arranged and adjacent to each other as much as possible in a premise of being located outside the range of the vertical field angle θv. In this way, the aforementioned disposition not only does not influence the image captured by the lens module 200, but also provides more space for the illuminant modules 300, and more illuminant modules 300 may be disposed, or the illuminant modules 300 may be disposed at specific positions in regions corresponding to the second portions TAII, thereby improving the design margin.

Referring to FIG. 4 and FIG. 1, in the present embodiment, a height of the first portion TAI of the transparent region TA of the front cover 120 in the vertical direction (i.e., the Y-axis) is substantially equal to the spacing H1 between the two light blocking components 121 in the vertical direction (i.e., the Y-axis). Additionally, in the present embodiment, a width of the first portion TAI of the transparent region TA of the front cover 120 in the horizontal direction (i.e., the X-axis) is W1, the width W1 of the first portion TAI is greater than the height, and the vertical field angle θv corresponding to the image capturing device 10 in the vertical direction (i.e., the Y-axis) is smaller than the horizontal field angle θh in the horizontal direction (i.e., the X-axis). In the present embodiment, the first portion TAI of the transparent region TA is located within the range covered by the vertical field angle θv, and the two second portions TAII of the transparent region TA is located outside the range covered by the vertical field angle θv. The lens module 200 may receive the light passing through the first portion TAI of the transparent region TA to obtain an image, and the light emitted by the illuminant modules 300 may pass through the two second portions TAII of the transparent region TA to achieve an effect to fill light.

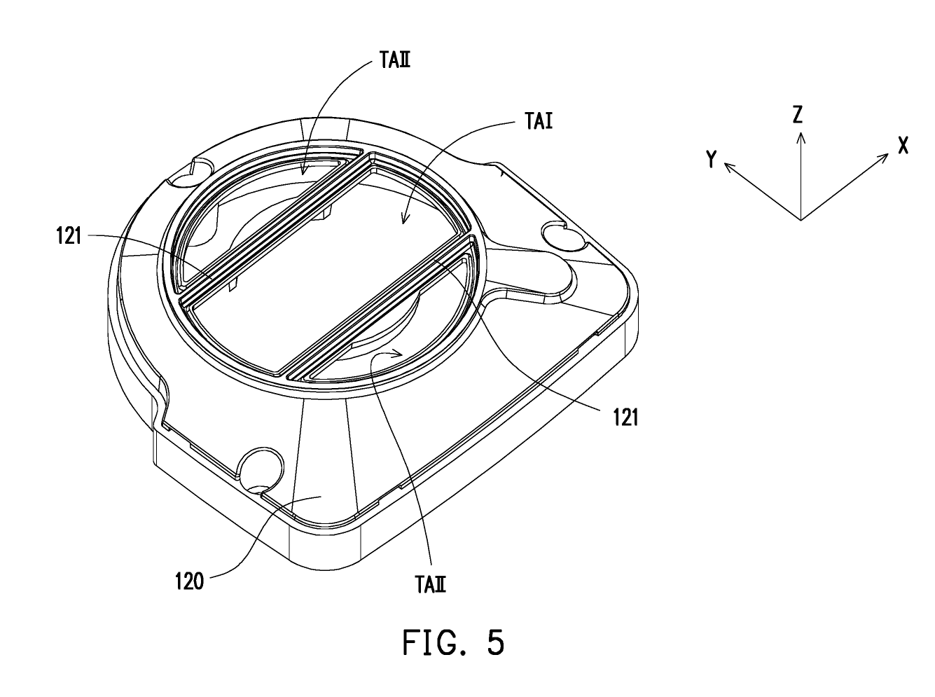

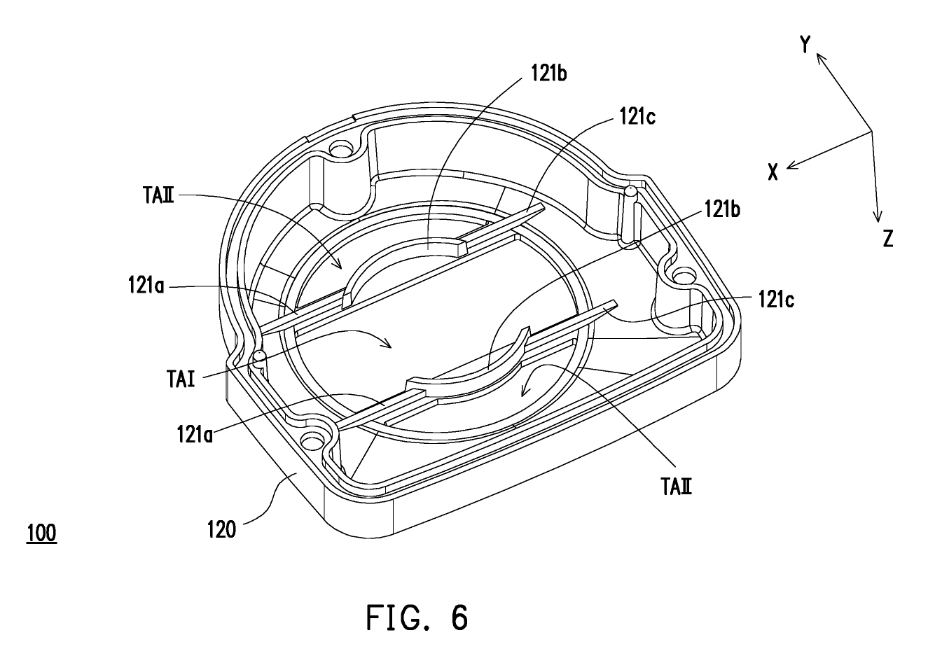

FIG. 5 is a schematic front top view showing the front cover of the image capturing device of embodiment depicted in FIG. 1. Referring to FIG. 5, FIG. 5 is illustrated in a view angle from the outside of the front cover 120, and the light blocking components 121 are bar-shaped. FIG. 6 is a schematic rear-top view showing the front cover of the image capturing device of embodiment depicted in FIG. 1. Referring to FIG. 6, FIG. 6 is illustrated in a view angle from the inside of the front cover 120. In the present embodiment, each of the light blocking components 121 includes a first section portion 121a, a second section portion 121b and a third section portion 121c which are sequentially connected. The first section portion 121a and the third section portion 121c are bar-shaped, and the second section portion 121b is arc-shaped. Returning to FIG. 3, in the present embodiment, the arc structures of the second section portions 121b are conformed at the lens 210 of the lens module 200, but the invention is not limited thereto. It is to be mentioned that in the present embodiment, the light blocking components 121 of the front cover 120 and the front cover 120 may be an integrated body. In other words, the light blocking components 121 and the front cover 120 may be simultaneously formed during a manufacturing process, such that a preferable binding strength is provided between the light blocking components 121 and the front cover 120, thereby improving impact resistance of the front side of the image capturing device 10, but the invention is not limited thereto.

FIG. 7 is a cross-sectional view of FIG. 3 taken through section line A-A′ which is parallel to the Y-Z plane illustrating a region near the front cover’. Referring to FIG. 7, in the present embodiment, the second section portions 121b of the light blocking components 121 of the front cover 120 are supported on a support base 400, thereby enhancing the structure strength of the front side of the image capturing device 10, but the invention is not limited thereto. Additionally, the arc structures of the light blocking components 121 are arranged between the illuminant modules 300 and the lens 210 of the lens module 200, thereby blocking the light of the illuminant modules 300 from directly irradiating, being reflected or refracted to the lens 210 to maintain the quality of the captured image, but the invention is not limited thereto.

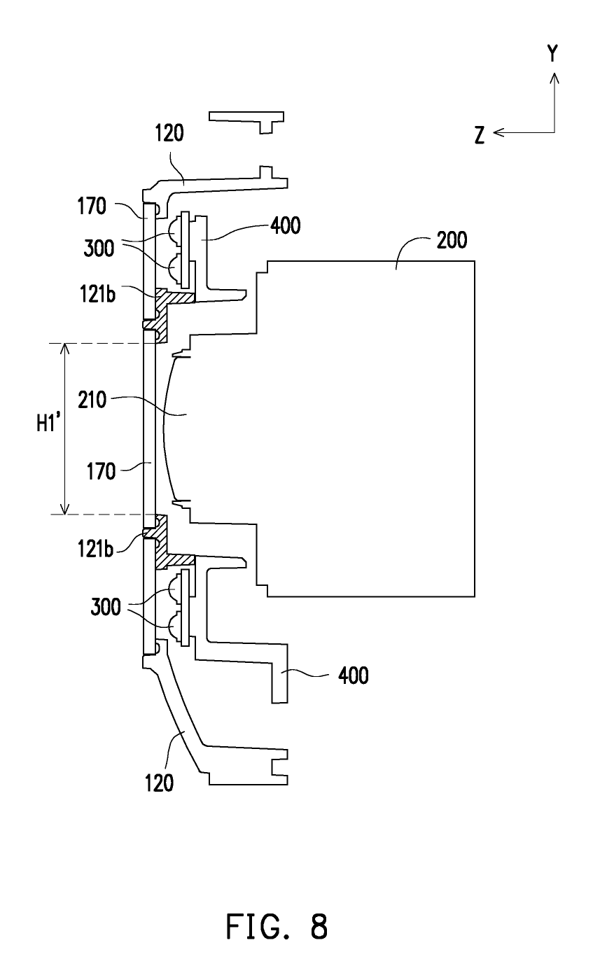

FIG. 8 is cross-sectional view of FIG. 3 taken through section line A-A′ which is parallel to the Y-Z plane illustrating a region near the front cover according to another embodiment of the invention. Referring to FIG. 8, it is different from the embodiment illustrated in FIG. 7 only in the spacing between the two light blocking components 121. In the present embodiment, a spacing between the two light blocking components 121 in the vertical direction (i.e., the Y-axis) is H1′ and is smaller than the spacing H1 between the two light blocking components 121 in the vertical direction (i.e., the Y-axis) in the embodiment illustrated in FIG. 7. In other words, the two light blocking components 121 are disposed more adjacent to the lens 210. In this way, the area of the two second portions TAII of the transparent region TA is increased, such that more illuminant modules 300 may be disposed in the two second portions TAII of the transparent region TA. It is to be mentioned that in the present embodiment, although the spacing H1′ between the two light blocking components 121 of the front cover 120 is smaller, and an image capturing size required for the image capturing device 10 is not influenced as the vertical field angle θv of the image capture device 10 is also smaller. However, the invention is not limited thereto, and in another embodiment, the spacing H1 between the two light blocking components 121 of the front cover 120 may be further reduced to be equal to the height H2 of the lens 210 of the lens module 200, thereby obtaining a larger space for disposing the illuminant modules 300.

In light of the foregoing, the image capturing device of the embodiments of the invention, with the presence of the light blocking components laterally disposed in the front cover, can achieve dividing the transparent region of the front cover into the first portion corresponding to the lens module and the second portions corresponding to the illuminant modules. The light blocking components can prevent the quality of the captured image from being influenced by blocking the light of the illuminant modules from directly irradiating, being reflected or refracted into the lens module. Moreover, as the laterally disposed light blocking components are located outside the range covered by the vertical field angle θv, the light blocking components can be adjacent to the lens as much as possible, such that more space can be acquired for disposing the illuminant modules in the premise that the lens module can retain the visible range. In addition, the two light blocking components and the front cover can be designed as an integrated body to provide more preferable structure strength for the front side of the case, and in cooperation with the second section portions of the light blocking components supported on the support base, the image capturing device can have preferable impact resistance.

Although the present invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. An image capturing device, comprising:
a case, having a front cover, wherein the front cover has a transparent region;
a lens module, arranged in the case and oriented toward the transparent region;
at least one illuminant module, arranged in the case and oriented toward the transparent region; and
at least one light blocking component, laterally arranged in the transparent region of the front cover, separating the lens module from the at least one illuminant module and dividing the transparent region into a first portion and at least one second portion, wherein the lens module corresponds to the first portion of the transparent region, and the at least one illuminant module corresponds to the at least one second portion of the at least one transparent region.

2. The image capturing device according to claim 1, wherein a width of the first portion of the transparent region is greater than a height of the first portion.

3. The image capturing device according to claim 2, wherein each of the at least one light blocking component comprises a first section portion, a second section portion and a third section portion which are sequentially connected, the first section portion and the third section portion are bar-shaped, and the second section portion is arc-shaped.

4. The image capturing device according to claim 2, wherein the lens module has a vertical field angle and a horizontal field angle, the vertical field angle is smaller than the horizontal field angle, the first portion of the transparent region is located in a range covered by the vertical field angle, and the at least one second portion of the transparent region is located outside the range covered by the vertical field angle.

5. The image capturing device according to claim 1, wherein the at least one light blocking component comprises two of the light blocking components which are separated from each other and respectively disposed in the transparent region of the front cover to divide the transparent region into the first portion and two of the second portions located at two sides of the first portion, the at least one illuminant module comprises a plurality of the illuminant modules, a part of the illuminant modules correspond to one of the second portions of the transparent region, and the other part of the illuminant modules correspond to the other one of the second portions of the transparent region.

6. The image capturing device according to claim 5, wherein each of the at least one light blocking component comprises a first section portion, a second section portion and a third section portion which are sequentially connected, the first section portion and the third section portion are bar-shaped, and the second section portion is arc-shaped.

7. The image capturing device according to claim 6, wherein shape of the second section portion is conformed at a lens of the lens module.

8. The image capturing device according to claim 5, wherein a distance between the two light blocking components is greater than or equal to a height of a lens of the lens module.

9. The image capturing device according to claim 8, wherein each of the at least one light blocking component comprises a first section portion, a second section portion and a third section portion which are sequentially connected, the first section portion and the third section portion are bar-shaped, and the second section portion is arc-shaped.

10. The image capturing device according to claim 9, wherein shape of the second section portion is conformed at a lens of the lens module.

11. The image capturing device according to claim 1, wherein the at least one light blocking component and the front cover are an integrated body.

12. The image capturing device according to claim 11, wherein the at least one light blocking component comprises two of the light blocking components which are separated from each other and respectively disposed in the transparent region of the front cover to divide the transparent region into the first portion and two of the second portions located at two sides of the first portion, the at least one illuminant module comprises a plurality of the illuminant modules, a part of the illuminant modules correspond to one of the second portions of the transparent region, and the other part of the illuminant modules correspond to the other one of the second portions of the transparent region.

13. The image capturing device according to claim 12, wherein each of the at least one light blocking component comprises a first section portion, a second section portion and a third section portion which are sequentially connected, the first section portion and the third section portion are bar-shaped, and the second section portion is arc-shaped.

14. The image capturing device according to claim 1, wherein the case comprises a main body portion, and the front cover is detachably assembled to the main body portion.

15. The image capturing device according to claim 1, wherein each of the at least one light blocking component comprises a first section portion, a second section portion and a third section portion which are sequentially connected, the first section portion and the third section portion are bar-shaped, and the second section portion is arc-shaped.

16. The image capturing device according to claim 15, further comprising:
a support base, arranged in the case and surroundingly disposed at a lens of the lens module, wherein the at least one illuminant module is disposed on the support base, and the second section portion is supported on the support base.

17. The image capturing device according to claim 16, wherein shape of the second section portion is conformed at a lens of the lens module.

18. The image capturing device according to claim 15, wherein shape of the second section portion is conformed at a lens of the lens module.

19. The image capturing device according to claim 1, further comprising:
a support base, arranged in the case and surroundingly disposed at a lens of the lens module, wherein the at least one illuminant module is disposed on the support base, and the second section portion is supported on the support base.

20. The image capturing device according to claim 1, wherein the at least one illuminant module comprises an infrared illuminant module.
